(19) United States
(12) Patent Application Publication
(10) Pub. No.: US 2004/0071060 A1
(43) Pub. Date: Apr. 15, 2004

(54) High-density optical disc, method for recording address and/or servo information on the high-density optical disc, and method for reproducing data recorded on the high-density optical disc

(76) Inventors: Sang Woon Suh, Seoul (KR); Jung Bae Park, Kyunggi-do (KR)

Correspondence Address: HARNESS, DICKEY & PIERCE, P.L.C., P.O. BOX 8910, RESTON, VA, 20195, US

(21) Appl. No.: 10/641,028

(22) Filed: Aug. 15, 2003

(30) Foreign Application Priority Data
Aug. 17, 2002 (KR) 10-2002-0048745
Sep. 11, 2002 (KR) 10-2002-0055099

(51) Int. Cl. G11B 7/0045

(52) U.S. Cl. 369/47.31

(57) ABSTRACT

A high-density optical disc, a method for recording address and/or servo information on the high-density optical disc, and a method for reproducing data recorded on the high-density optical disc. Data is recorded on the high-density optical disc in units of a RUB (Recording Unit Block) having a predetermined size equal to that of an ECC (Error Correction Code) unit. Address information of the RUB and/or Spindle index information of predetermined channel bits needed for a spindle servo control operation are/is recorded in a first linking area or a second linking area of the RUB. Therefore, address information and/or spindle index information can be quickly recognized without using an additional complicated decoding operation during a playback time of an optical disc player, such that a user-desired specific position can be randomly accessed and a CLV-based spindle servo operation can be easily controlled.

### BACKGROUND OF THE INVENTION

1. Field of the Invention

The present invention relates to a method for recording data of a high-density optical disc, and more particularly to a high-density read-only optical disc, a method for recording address and/or servo information on the high-density read-only optical disc such as a BD-ROM (Blu-ray Disc Read Only Memory), and a method for reproducing data recorded on the high-density read-only optical disc.

2. Description of the Related Art

In recent times, there has been newly developed a high-density optical disc capable of storing high-quality video data and high-quality audio data having a long playback time, for example, a BD-RE (Blu-ray Disc Rewritable). Referring to FIG. 1, the BD-RE 100 is comprised of a plurality of zones, for example, a clamping area, a transition area, a BCA (Burst Cutting Area), a Lead-In zone, a data zone, a Lead-Out Zone, etc.

Data of the SD-RE 100 is recorded on the BD-RE 100 while being classified in RUB (Recording Unit Blocks) units each having the same length as one ECC (Error Correction Code) block unit, as shown in FIG. 2.

For example, provided that data having temporal continuity is capable of being recorded in a single RUB (Recording Unit Block), the RUB is comprised of a Data Run-In of 2760 channel bits, a physical cluster of 958272 channel bits, and a Data Run-Out of 1104 channel bits. A guard-3field of 540 channel bits is connected to the end of the RUB.

On the other hand, provided that such data having temporal continuity is recorded in a plurality of RUBs instead of being recorded in the single RUB, the data is successively recorded in RUBs each composed of the Data Run-In, the physical cluster, and the Data Run-Out, and is then recorded in one guard-3 field. The guard-3 field is adapted to previously prevent the next data after completing the recording of data from overlapping with previous recorded data.

The Data Run-In of the RUB is comprised of a guard-1 field of 1100 channel bits and a pre-amble field of 1660 channel bits, as shown in FIG. 3. A pattern having 20 channel bits for identifying the head of the RUB is repeatedly recorded in the guard-1 field 55 times.

The Data Run-Out of the RUB is comprised of a post-amble field of 564 channel bits and a guard-2 field of 540 channel bits. A pattern having 20 channel bits for identifying an end portion of the RUB is repeatedly recorded in the guard-2 field 27 times.

A pattern having 20 channel bits for identifying the end of a data recording operation is repeatedly recorded in the guard-3 field 27 times, such that the head and end portions of the RUB and a data recording termination position can be identified by an optical disc device such as an optical disc recorder.

Data recorded on the BD-RE 100 contains address information for randomly accessing the RUB corresponding to one ECC block unit. The address information is modulated/encoded with A/V data and is recorded on the BD-RE 100, such that the address information is distributed to the physical cluster contained in the RUB. Therefore, all data recorded on the RUB should be read, demodulated, and decoded to read the address information, such that an optical disc recorder or an optical disc player not only increases its own system load, but also does not quickly perform a random access operation of data.

Wobble-shaped physical address information for finding or randomly accessing a data recording position is previously recorded on the BD-RE 100. The wobble-shaped physical address information is detected in the form of a low-frequency wobble signal, and is adapted to a spindle servo unit of a CLV (Constant Linear Velocity) type. Therefore, the optical disc device such as an optical disc recorder detects the low-frequency wobble signal during a data recording time or a data playback time in such a way that the CLV-based spindle servo unit can be normally controlled.

Recently, there has been newly developed a high-density read-only optical disc such as a BD-ROM, and many developers have conducted intensive research into the high-density read-only optical disc and its standardization. However, there has not been provided any effective address information recording solution for performing more quickly a random access operation of data recorded on the optical disc. Furthermore, because data in the form of a straight pit is recorded on the high-density read-only optical disc and wobble-shaped physical address information such as a BD-RE is not additionally recorded on the high-density read-only optical disc, the CLV-based spindle servo operation is not effectively performed. In conclusion, there must be newly developed an effective address information recording method for solving the aforementioned problems.

### SUMMARY OF THE INVENTION

Therefore, the present invention has been made in view of the above problems, and it is an object of the present invention to provide a high-density optical disc, an effective address information recording method for quickly performing a random access operation of data recorded on the high-density optical disc, a servo information recording method for effectively performing a CLV-based spindle servo operation without additionally recording wobble-shaped physical address information on the high-density optical disc, and a method for reproducing data recorded on the high-density optical disc.

In accordance with one aspect of the present invention, the above and other objects can be accomplished by the provision of a method for recording address and/or servo information on a recording medium, comprising the step of: recording address information of a recording unit of the recording medium in a specific area contained in either a first linking area or a second linking area of the recording unit, wherein the address information is recorded in the specific area along with data for identifying the first linking area or the second linking area.

In accordance with another aspect of the present invention, there is provided a method for recording information on a recording medium, comprising the step of: recording servo control information needed for a spindle servo control operation of the recording medium in either a first linking area or a second linking area of a recording unit having a predetermined size.

In accordance with yet another aspect of the present invention, there is provided a recording medium, comprising: a first linking area and/or a second linking area, wherein data is recorded in a recording unit, address information of the recording unit is recorded in a specific area contained in either the first linking area or the second linking area of the recording unit, and the address information is recorded in the specific area along with data for identifying the first linking area or the second linking area.

In accordance with yet a further another aspect of the present invention, there is provided a recording medium, comprising: a first linking area and/or a second linking area, wherein data is recorded in a recording unit, and servo control information needed for a spindle servo control operation is recorded in either the first linking area or the second linking area of the recording unit.

In accordance with yet a further another aspect of the present invention, there is provided a method for reproducing data recorded on a recording medium, comprising the steps of: a) reading information recorded in a linking area of the recording medium; and b) performing a servo control based upon the read information, to reproduce data recorded on the recording medium.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows an internal structure of a BD-RE;

FIG. 2 shows a an RUB (Recording Unit Block) of the BD-RE;

FIG. 3 shows a Data Run-In, a Data Run-Out, and a guard-3 field contained in the RUB (Recording Unit Block) of the BD-RE;

FIG. 4 shows an internal structure of a BD-ROM in accordance with the present invention;

FIG. 5 shows the appearance of spindle index information recorded in a Data Run-In of the BD-ROM in accordance with the present invention;

FIG. 6 shows the appearance of spindle index information recorded in a Data Run-Out of the BD-ROM in accordance with the present invention;

FIG. 7 shows the appearance of the Data Run-In of the BD-ROM in which zone ID information is recorded in accordance with the present invention;

FIG. 8 shows the appearance of the Data Run-Out of the BD-ROM in which zone ID information is recorded in accordance with the present invention;

FIGS. 9 and 10 show internal structures of the Data Run-In of the BD-ROM in which address information is recorded in accordance with the present invention;

FIGS. 11 and 12 show internal structures of the Data Run-Out of the BD-ROM in which address information is recorded in accordance with the present invention; and

FIG. 13 is a block diagram of an optical disc device for reproducing data recorded on the BD-ROM in accordance with the present invention.

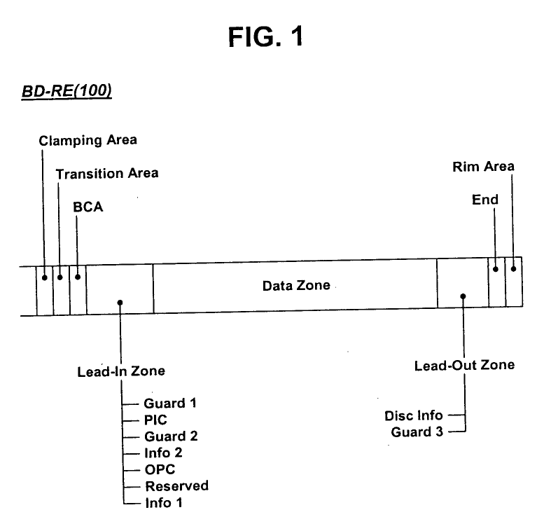

### DETAILED DESCRIPTION OF PREFFERRED EMBODIMENTS

Now, preferred embodiments of the present invention will be described in detail with reference to the annexed drawings.

A high-density optical disc, a method for recording address and/or servo information on the high-density optical disc, and a method for reproducing data recorded on the high-density optical disc will hereinafter be described in detail.

The method for recording address and/or servo information on the high-density optical disc can be applicable to a method for manufacturing a BD-ROM.

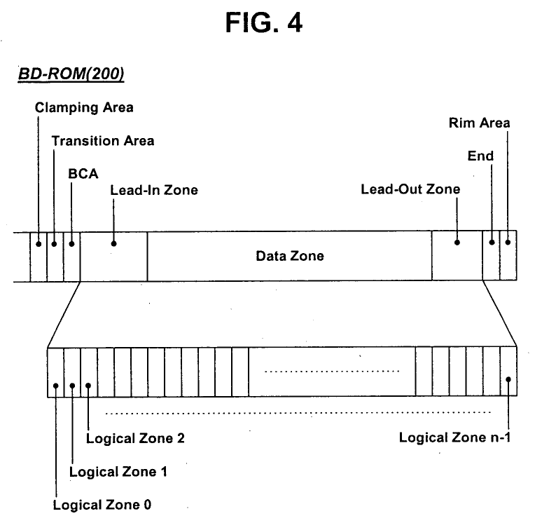

FIG. 4 shows an internal structure of a BD-ROM 200 in accordance with the present invention. The BD-ROM 200 is comprised of a clamping area, a transition area, a BCA (Burst Cutting Area), a Lead-In zone, a data zone, and a Lead-Out zone, etc. All of the Lead-In zone, the data zone, and the Lead-Out zone or some parts of them can be divided into N logical zones 0˜(n-1) each having a predetermined size.

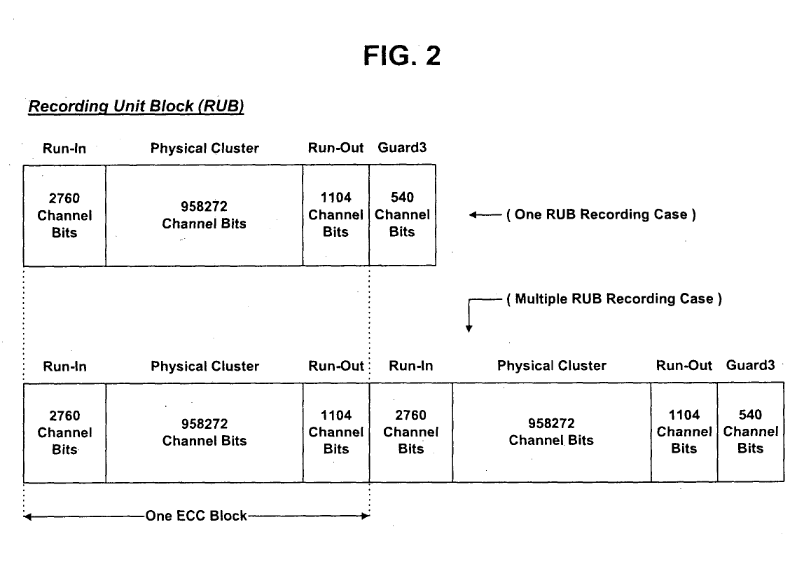

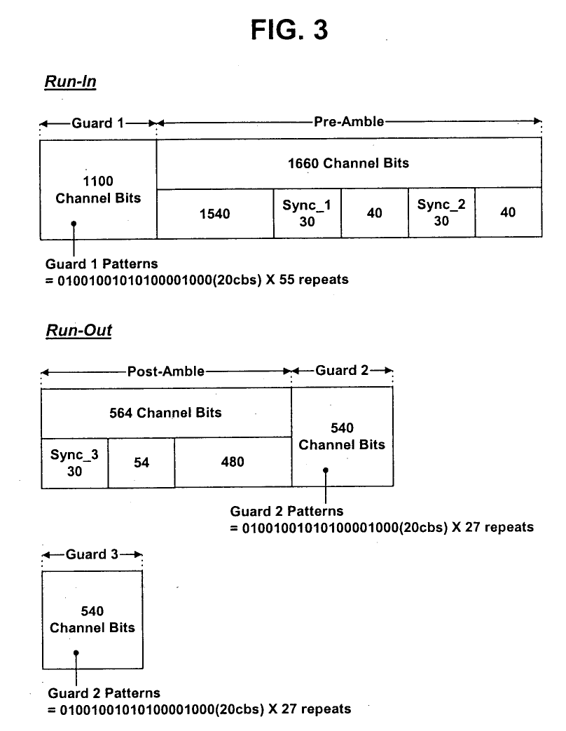

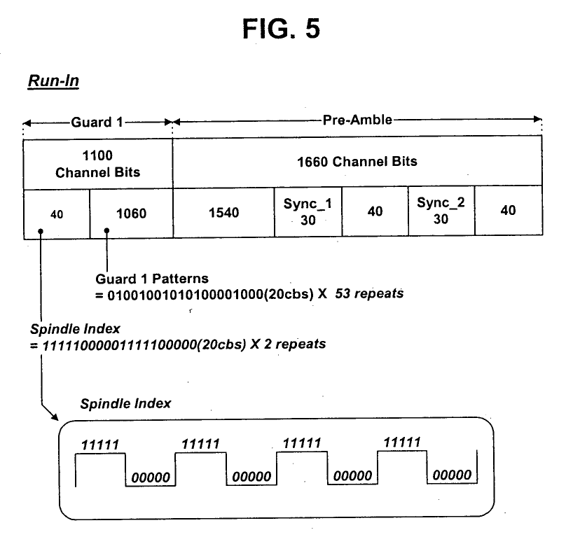

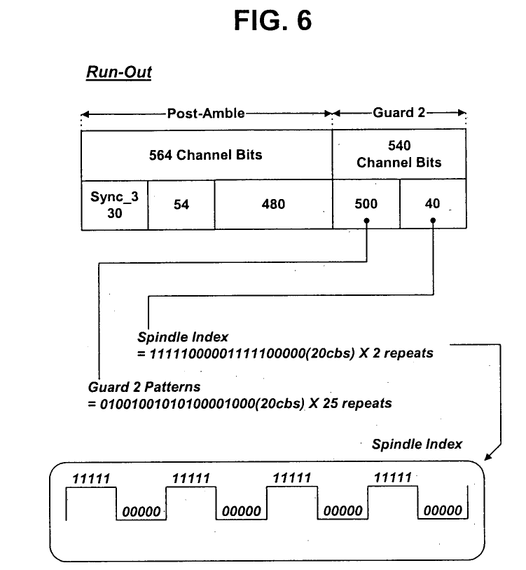

Data is recorded on the BD-ROM 200 while being classified in RUB units each having the same length as one ECC block unit, as shown in FIG. 2. The Data Run-In of 2760 channel bits contained in the RUB is divided into a guard-1 field of 1100 channel bits and a pre-amble field of 1660 channel bits, as shown in FIG. 5. The Data Run-Out of 1104 channel bits contained in the RUB is divided into a post-amble field of 564 channel bits and a guard-2 field of 540 channel bits, as shown in FIG. 6.

As shown in FIG. 5, spindle index information composed of 40 channel bits is recorded in the guard-1 field, and a pattern having 20 channel bits for identifying the head of the RUB is repeatedly recorded 53 times in the guard-1 field. In this case, the pattern having 20 channel bits can identify that a current area is a linking area (e.g., a Data Run-In or a Data Run-Out), and additional ID (Identification) data can also be recorded in the guard-1 field. Further, as shown in FIG. 6, spindle index information of 40 channel bits can be recorded in the guard-2 field contained in the Data Run-Out of the RUB. In this case, a pattern having 20 channel bits for identifying the end of the RUB is repeatedly recorded 25 times in the guard-2 field. On the other hand, the spindle index information of 40 channel bits can be created by repeatedly recording another spindle index information of 20 channel bits two times.

For example, provided the BD-ROM is a 23G-grade BD-ROM, one RUB has a predetermined length of 0.077 m or 0.07687 m (i.e., 962676 channel bits (cbs)×80 (nm/cbs)=0.077 m or 962136 cbs×80 (nm/cbs)=0.07687 m). Because a data reading velocity is 5.28 m/s, spindle index information recorded in the RUB is detected at intervals of a predetermined period 68.571 Hz (i.e., 0.014583 sec=0.077 m÷5.28 m/s). Provided that the BD-ROM is a 27-grade BD-ROM, one RUB has a predetermined length of 0.0664 m or 0.06638 m (i.e., 962676 cbs×69 (nm/cbs)=0.0664 m or 962136 cbs×69 (nm/cbs)=0.06638 m). Because a data reading velocity is 5.28 m/s, spindle index information recorded in the RUB is detected at intervals of a predetermined period 80.0 Hz (i.e., 0.0125 sec=0.066 m÷5.28 m/s).

On the other hand, general channel bit data is detected in the form of a high frequency signal of 66 MHz. Therefore, an optical disc player can correctly discriminate between spindle index information detected at a low period of either 68.571 MHz or 80.0 HZ and such general channel bit data having a high frequency signal of 66 MHz.

The spindle index information of 40 channel bits can distinguish its data pattern from a general data pattern without its own decoding operation, such that it can serve as physical address information needed for a CLV-based spindle servo control operation. In more detail, provided that the BD-ROM 200 is loaded in the optical disc player, the optical disc player recognizes a detection period of spindle index information based upon an RF (Radio Frequency) signal read from the BD-ROM 200 without decoding the RF signals, and performs a spindle servo operation on the basis of the recognized period.

In the meantime, if all data recorded on an optical disc is read at one linear velocity, a rotation speed of an innermost data track of the optical disc is at least two times faster than a rotation speed of an outermost data track of the optical disc. Therefore, in the case of increasing a data recording/reading speed of the optical disc, a rotation speed at the innermost data track also increases, resulting in increasing load to a spindle motor. To solve this problem, there has been a CAV method for varying a data rate (i.e., a data recording/reading speed of the optical disc) according to data track position (i.e., an innermost or outermost data track) of the optical disc at a constant disc rotation speed. In more detail, the data rate gradually increases in the direction from an innermost data track to an outermost data track. According to a zone CLV method similar to the CAV method, a data on an optical disc is divided into a plurality of data sub-fields (e.g., an innermost data field, a center data field, an outermost data field) in proportion to a radius of the optical disc, and the same sub-field has a constant linear velocity whereas individual sub-fields have different linear velocities. By the zone CLV method a data recording/reading speed at an innermost data field of the optical disc is low in spite of a high rotation speed of a spindle motor at the innermost data field. But the closer the outermost data track, the higher the data recording/reading speed without increasing the rotation speed of the spindle motor.

If the zone CLV method is applied to a spindle servo control operation of the optical disc, information about a currently recorded/reproduced disc zone is needed. In more detail, the zone CLV method needs address information associated with the currently recorded/reproduced data zone, for example, radius information, a unit number, and a physical sector number, etc. Linear velocity data for individual data zones corresponds to disc information, such that it can be stored in a BCA (Burst Cutting Area), a Lead-In zone, or a Lead-Out zone in the form of data table.

If the zone CLV method is applied to the optical disc containing the spindle index information, data associated with detection periods of spindle index information for individual zones can be stored in the BCA, the Lead-In zone, or the Lead-Out zone. In the case of reproducing data of the optical disc, data stored in the BCA zone and the like is firstly read out prior to reproducing the data of the optical disc, such that a spindle servo operation can be performed according to the zone CLV method based upon the read data, information associated with a data zone detected during a playback time of the optical disc, and detection period of spindle index information detected from read RF signals.

For reference, the spindle index information can also be adapted for another purpose other than the aforementioned spindle servo control function.

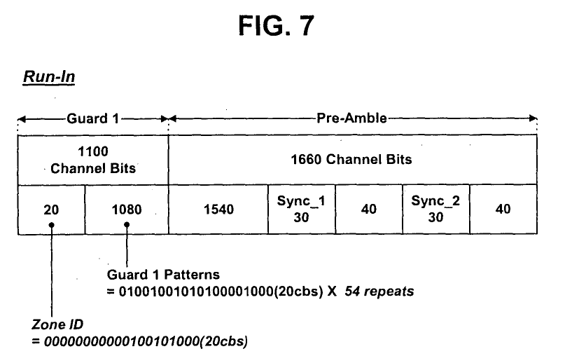

As shown in FIG. 7, the guard-1 field includes zone ID information of 20 channel bits for identifying individual logical zones and pattern information having 20 channel bits for identifying the head of the RUB. The pattern information having 20 channel bits is repeatedly recorded 54 times in the guard-1 field. The zone ID information is managed as address information for randomly accessing a RUB.

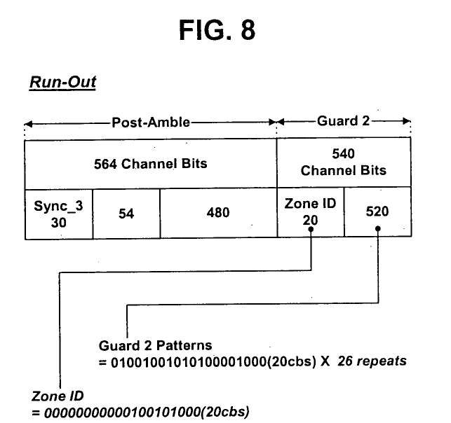

The zone ID information can be recorded in the guard-2 field contained in a Data Run-Out of 1104 channel bits contained in the RUB, as shown in FIG. 8. The guard-2 field includes the zone ID information of 20 channel bits and pattern information of 20 channel bits for identifying the end of the RUB. In this case, the pattern information can be repeatedly recorded 26 times in the guard-2 field.

Therefore, an optical disc apparatus which plays the BD-ROM 200 including unique zone ID information corresponding to address information of a logical zone in either the guard-1 field of the Data Run-In or the guard-2 field of the Data Run-Out quickly recognizes the zone ID information without an additional complicated decoding operation, such that a user-desired specific position of the optical disc can be randomly accessed.

In the meantime, it can be recognized that a current recording position is a Lead-In zone, a data zone or a Lead-out zone using some parts of the zone ID information recorded in either the guard-1 field of the Data Run-In or the guard-2 field of the Data Run-Out. For example, if two channel bits positioned at the head of the zone ID information of 20 channel bits are set to “00”, it is determined that the current recording position is the Lead-In zone. If the two channel bits are set to “01”, it is determined that the current recording position is the data zone. If the two channel bits are set to “10”, it is determined that the current recording position is the Lead-Out zone.

Therefore, the optical disc apparatus recognizes front two channel bits contained in the zone ID information of 20 channel bits, such that it can quickly perform a long jump between the zones such as the Lead-In zone, the Data zone, and the Lead-Out zone.

In the meantime, although the BD-ROM 200 is not divided into a plurality of logical zones, address information of 20 channel bits contained in a RUB having the same length as an ECC block unit is recorded in either the guard-1 field of the Data Run-In or the guard-2 field of the Data Run-Out. During a playback time, the address information of the RUB is quickly recognized without an additional complicated decoding operation, such that a user-desired specific recording position can be randomly accessed.

In the meantime, a method for recording address information of a RUB in a guard zone of either the Data Run-In or the Data Run-Out to more quickly find the RUB having the same length as an ECC block unit will hereinafter be described in detail.

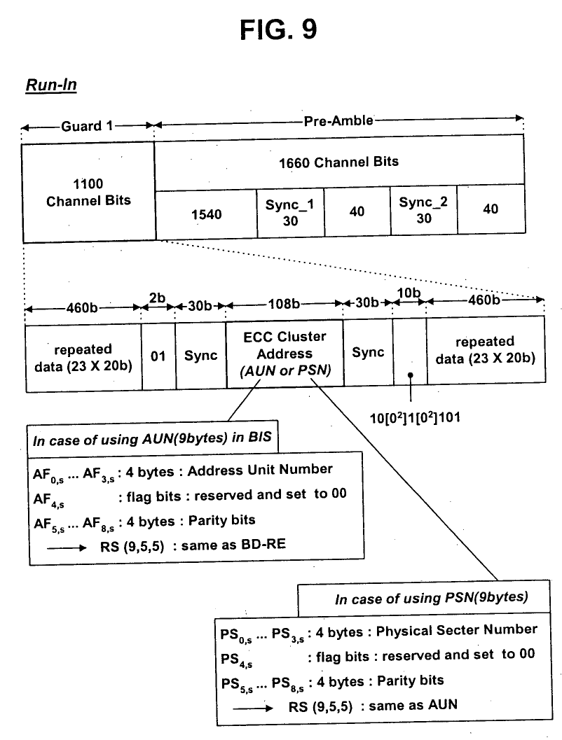

As shown in FIG. 9, if the address information is recorded in the guard-1 field of the Data Run-In, first data of 20 channel bits positioned at the head of the guard-1 field having 1100 channel bits is adapted to indicate a guard-1 field of the Data Run-In, and is repeatedly recorded 23 times in the head of the guard-1 field. Second data of 20 channel bits positioned at the end of the guard-1 field is also adapted to indicate such a guard-1 field of the Data Run-In, and is also repeatedly recorded 23 times in the end of the guard-1 field. Address information having a predetermined channel bit length, synchronous data, and alignment bit information for adjusting the number of channel bits are located between the first and second data.

For example, an ECC cluster address of 108 channel bits is recorded, alignment bit information “01” of two bits and synchronous data of 30 bits are connected to the head of the ECC cluster address, and the end of the ECC cluster address is connected to another synchronous data of 30 channel bits and alignment bit information 10[0²]1[0²]101 of 10 channel bits in such a way that the number of all channel bits contained in the first and second data and middle data located between the first and second data is equal to the number “1100” of channel bits contained in the guard-1 field.

The ECC cluster address is comprised of AUN (Address Unit Number) information of 4 bytes, reserved information of 1 byte, and parity bit information of 4 bytes, such that it has a predetermined size of 72 bits in total. In this case, the ECC cluster address of 72 bits is processed by a well-known RS (Reed-Solomon) encoding method such as an RS(9,5,5) encoding method, such that it is recorded in the guard-1 field in the form of 108 channel bits (i.e., 72×(3/2)).

The ECC cluster address may be comprised of PSN (Physical Sector Number) information of 4 bytes, reserved information of 1 byte, and parity bit information of 4 bytes, such that it may have a predetermined size of 72 bits in total. In this case, the ECC cluster address is also processed by the RS (9,5,5) encoding method, such that it is recoded in the form of 108 channel bits (i.e., 72×(3/2)).

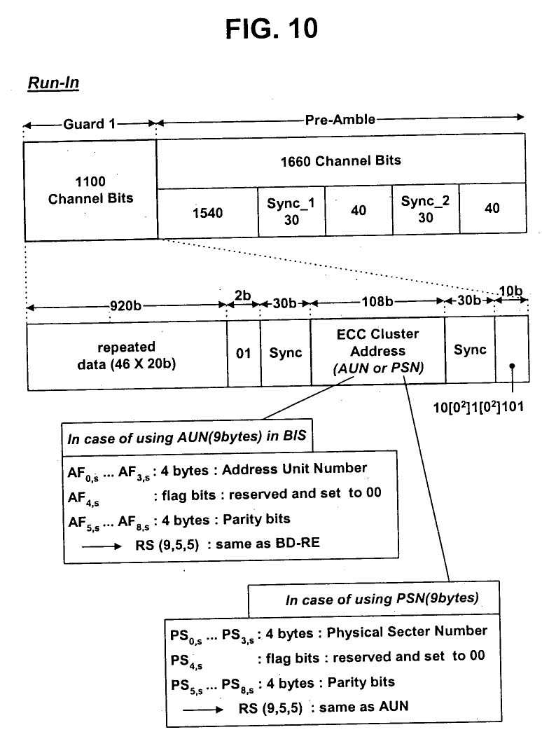

The above address information can be recorded in the head or end of the guard-1 field. For example, as shown in FIG. 10, provided that the address information is recorded in the end of the guard-1 field, data composed of 20 channel bits indicating that a current field is the guard-1 field of the Data Run-In is repeatedly recorded 46 times in the guard-1 field, address information of 108 bits, synchronous data, and alignment bit information for adjusting the number of total channel bits are connected to the end of the address information.

The address information, i.e., an ECC cluster address, is composed of either one of AUN and PSN information, reserved information of 1 byte, and parity bit information 4 bytes, such that it has a predetermined size of 72 bits in total. In this case, the ECC cluster address composed of 72 bits is processed by the RS (9,5,5) encoding method, such that it is recorded in the guard-1 field in the form of 108 channel bits (i.e., 72×(3/2)).

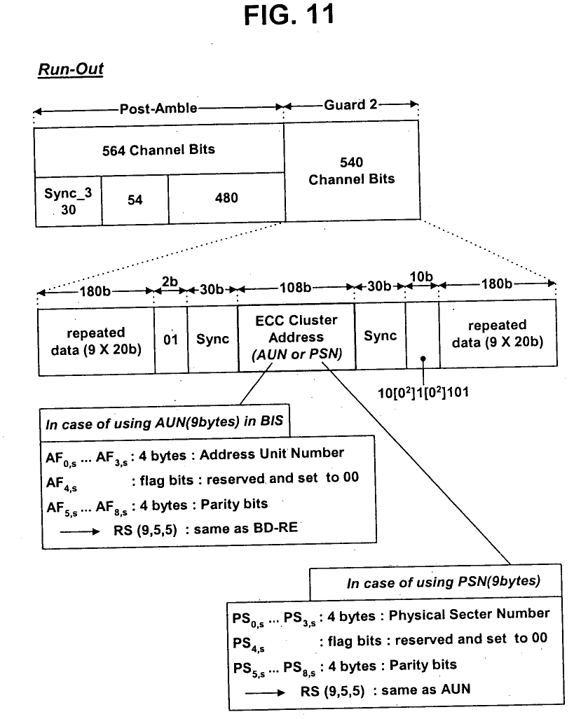

The address information may also be recorded in the guard-2 field of the Data Run-Out. For example, as shown in FIG. 11, first data of 20 channel bits positioned at the head of the guard-2 field composed of 540 channel bits is adapted to indicate a guard-2 field of the Lead-Out zone, and is repeatedly recorded 9 times in the head of the guard-2 field, thereby occupying 180 channel bits at the head of the guard-2 field. Second data of 20 channel bits positioned at the end of the guard-2 field is adapted to indicate such a guard-2 field of the Lead-Out zone, and is also repeatedly recorded 9 times in the end of the guard-2 field, thereby occupying 180 channel bits at the end of the guard-2 field. Address information composed of 108 channel bits, synchronous data, and alignment bit information for adjusting the number of channel bits are located between the first and second data.

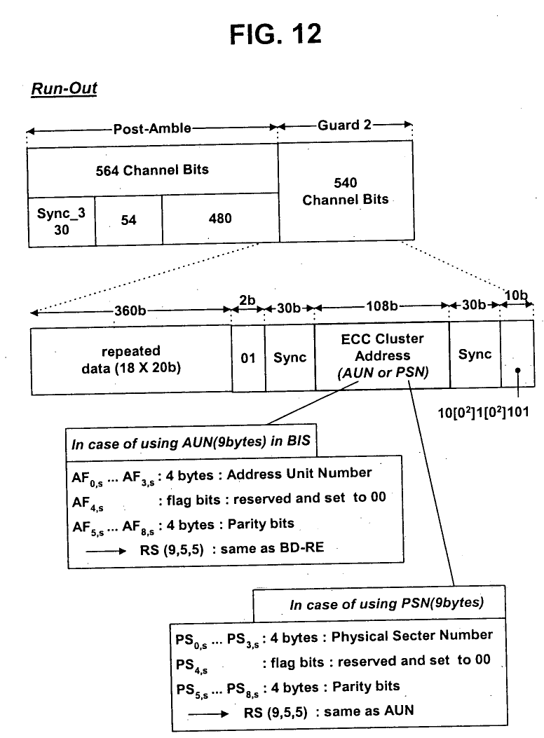

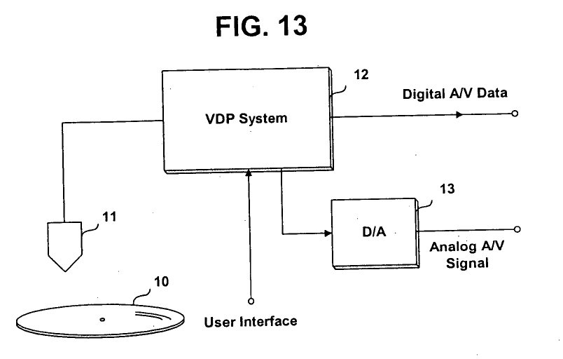

Referring to FIG. 12, first data information of 20 channel bits positioned at the head of the guard-2 field is adapted to indicate a guard-2 field of the Lead-Out zone, and is repeatedly recorded 18 times in front channel 360 bits of the guard-2 field. Address information of 108 channel bits, synchronous data, and alignment bit information may be added to the first data information.

The inventive address information is encoded by a RS (Reed-Solomon) code for use in an RS(9,5,5) encoding method. In the meantime, information of address and data is recorded on the BD-RE in the form of a BIS (Burst Indicator Subcode) encoded by an RS (62,30,33) encoding method. Therefore, a BIS decoding process needs a complicated calculation step to read address information from the BD-RE. However, the inventive address information can be obtained by a simple decoding method without using the complicated calculation step such as a BIS decoding process, thereby rapidly accessing data of the RUB.

As shown in FIGS. 9 to 12, spindle index information is recorded in some parts of channel bits repeatedly recorded to indicate either the guard-1 field or the guard-2 field even when address information is recorded in either the guard-1 field of the Data Run-In or the guard-2 field of the Data Run-Out, such that a CLV-based spindle servo operation can be easily performed. Base upon address information detected by a simple decoding operation, detection period of spindle index information detected from read RF signals, and linear velocity data for individual zones read from a BCA, etc., a zone CLV-based spindle servo operation can also be performed.

In the meantime, the Data Run-In and the Data Run-Out contained in a RUB having BD-ROM data are similar to those of the BD-RE, as previously stated. However, the Data Run-In and the Data Run-Out of the RUB of a BD-ROM are not necessarily equal to those of the BD-RE.

In more detail, individual sizes of the Data Run-In and Data Run-Out are not necessarily equal to those of the BD-RE, and a size of the Data Run-In is not necessarily different from that of the Data Run-out in the BD-ROM. The BD-RE needs to control the Data Run-In serving as a preparation area for recording data in the RUB to be larger than the Data Run-out serving as an area for discriminating between a data recording termination position and the next RUB. However, the BD-ROM needs to control the Data Run-In and Data Run-Out to discriminate between two adjacent blocks, such that the size of the Data Run-In is not necessarily different from that of the Data Run-Out, and the Data Run-In may even have the same size as the Data Run-out. The Data Run-In and Data Run-Out may also be called first and second linking frame, first and second linking area, or front and rear separation area, etc.

As shown in the above description, this invention provides a high density read-only optical disc, a method for recording address and/or servo information on the high-density read-only optical disc and a method for reproducing data recorded on the high-density read-only optical disc, but this invention also can be applied to the high-density rewritable or recordable optical disc (BD-RE or BD-WO), using the above method.

The optical disc apparatus for reproducing data of the BD-ROM 200 may be comprised of an optical pickup unit 11, a VDP (Video Disc Player) system 12, and a DAC (Digital-to-Analog Converter) 13.

In detail, optical pickup reproduces data from the BD-ROM in response to the control of VDP system. The VDP system includes demodulation circuit, servo controller and microcomputer, etc (not shown). DAC 13 output an analog signal after converting the digital data into the analog form.

In case of recording data on BD-RE or BD-WO, the optical pickup records or reproduces the data on the recording medium, in response to the control of a VDR (Video Disc Recorder) system. The VDR system instead of VDP system is prepared to record or reproduce data on the BD-RE or BD-WO. In particular, VDR system includes a modulator for modulating the data according to a predetermined modulation method, servo controller for controlling servo operation, and microcomputer for controlling the optical disc apparatus overall (not shown).

As apparent from the above description, the present invention provides a high-density optical disc, a method for recording address and/or servo information on the high-density optical disc, and a method for reproducing data recorded on the high-density optical disc. Therefore, it quickly recognizes address information and/or spindle index information without using an additional complicated decoding operation during a playback time of an optical disc player, such that a user-desired specific position can be randomly accessed and a CLV-based spindle servo operation can be easily performed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for recording information on a recording medium, comprising the step of:
recording address information of a recording unit of the recording medium in a specific area contained in either a first linking area or a second linking area of the recording unit,
wherein the address information is recorded in the specific area along with data for identifying the first linking area or the second linking area.

2. The method as set forth in claim 1, wherein address information is recorded between predetermined data repeatedly recorded to identify the first linking area or the second linking area, or is recorded in either one of front and rear ends of the predetermined data.

3. The method as set forth in claim 1, wherein the address information includes either one of an address unit number (AUN) and a physical sector number (PSN).

4. The method as set forth in claim 1, wherein the address information includes one of the address unit number (AUN) and the physical sector number (PSN), parity bit information, and reserved information.

5. The method as set forth in claim 1, wherein synchronous data of a predetermined length and alignment data are recorded in each of front end and rear end of the address information.

6. A method for recording information on a recording medium, comprising the step of:
recording servo control information needed for a spindle servo control operation of the recording medium in either a first linking area or a second linking area of a recording unit having a predetermined size.

7. The method as set forth in claim 6, wherein the servo control information is recorded in a specific area of either the first linking area or the second linking area.

8. The method as set forth in claim 6, wherein the servo control information serves as information needed for a CLV(Constant Linear Velocity)-based spindle servo control operation.

9. A recording medium, comprising:
a first linking area and/or a second linking area,
wherein data is recorded in a recording unit,
address information of the recording unit is recorded in a specific area contained in either the first linking area or the second linking area of the recording unit, and
the address information is recorded in the specific area along with data for identifying the first linking area or the second linking area.

10. The recording medium as set forth in claim 9, wherein address information is recorded between the data recorded to identify the first linking area or the second linking area, or is recorded in either one of front and rear ends of the data.

11. The recording medium as set forth in claim 9, wherein the address information includes either one of an address unit number (AUN) and a physical sector number (PSN).

12. The recording medium as set forth in claim 9, wherein the address information includes one of the address unit number (AUN) and the physical sector number (PSN), parity bit information, and reserved information.

13. The recording medium as set forth in claim 9, wherein synchronous data of a predetermined length and alignment data are recorded in each of front end and rear end of the address information.

14. A recording medium, comprising:
a first linking area and/or a second linking area,
wherein data is recorded in a recording unit, and
servo control information needed for a spindle servo control operation is recorded in either the first linking area or the second linking area of the recording unit.

15. The recording medium as set forth in claim 14, wherein the servo control information is recorded in a specific area of either the first linking area or the second linking area.

16. The recording medium as set forth in claim 14, wherein the servo control information serves as information needed for a CLV(Constant Linear Velocity)-based spindle servo operation.

17. A method for reproducing data recorded on a recording medium, comprising the steps of:
a) reading information recorded in a linking area of recording medium; and
b) performing a servo control based upon the read information, to reproduce data recorded on the recording medium.

18. The method as set forth in claim 17, wherein the read information of the step (a) is address information and/or spindle servo information.

19. The method as set forth in claim 18, wherein the address information includes either one of an address unit number (AUN) and a physical sector number (PSN).

20. The method as set forth in claim 18, wherein the step (b) includes the step of:
recognizing a current playback position using the address information.

21. The method as set forth in claim 18, wherein the spindle servo information is recorded a predetermined number of times in the form of repeated pit and space of a predetermined length.

22. The method as set forth in claim 18, wherein the step (b) includes the step of:
controlling the recording medium according to a CLV (Constant Linear Velocity) method based upon the spindle servo information.

23. The method as set forth in claim 18, wherein the step (b) includes the step of:
controlling the recording medium according to a zone-CLV method based upon the spindle servo information.

24. The method as set forth in claim 18, wherein the step (b) includes the step of:
controlling the recording medium according to a CAV (Constant Angular Velocity) method based upon the spindle servo information.
